(19) United States
(12) Patent Application Publication
(10) Pub. No.: US 2025/0159504 A1
(43) Pub. Date: May 15, 2025

(54) COMMUNICATION METHOD AND APPARATUS

(71) Applicant: HUAWEI TECHNOLOGIES CO., LTD., Shenzhen (CN)

(72) Inventors: Dongdong WEI, Shenzhen (CN); Hao TANG, Shanghai (CN)

(21) Appl. No.: 19/019,824

(22) Filed: Jan. 14, 2025

Related U.S. Application Data
(63) Continuation of application No. PCT/CN2022/105952, filed on Jul. 15, 2022.

(51) Int. Cl. H04W 24/02; H04W 24/10; H04W 76/20

(52) U.S. Cl. CPC H04W 24/02; H04W 24/10; H04W 76/20

(57) ABSTRACT

A communication method and an apparatus are provided. After determining a first split point based on first information, a first apparatus sends second information to a second apparatus, where the second information indicates the first split point. The second apparatus uses the first split point based on the second information. The first split point corresponds to a first model, and the first model is used for split learning. The first information may include one or more of the following: a split point expected by a terminal, electricity quantity information of the terminal, a storage capability of the terminal, computing power of the terminal, or a measurement result related to channel quality.

### CROSS-REFERENCE TO RELATED APPLICATIONS

This application is a continuation of International Application No. PCT/CN2022/105952, filed on Jul. 15, 2022, the disclosure of which is hereby incorporated by reference in its entirety.

### TECHNICAL FIELD

This application relates to the field of communication technologies, and in particular, to a communication method and an apparatus.

### BACKGROUND

In recent years, artificial intelligence (AI) technologies develop rapidly. In particular, benefited from breakthroughs in artificial intelligence algorithm capabilities represented by deep learning, reinforcement learning, and the like, and a rapid reduction in costs of artificial intelligence computing power represented by a graphics processing unit (GPU), artificial intelligence achieves great success in fields such as computer vision, natural language processing, and robot control.

For a wireless network, starting from a 5th generation (5G) system, an artificial intelligence algorithm has been applied to a mobile network, for example, network configuration optimization at a network management level and air interface algorithm optimization. It is foreseeable that the AI may play an increasingly important role in the wireless network for a 5.5G system and a 6G system, and provide more functions, to make a network more intelligent. For example, native AI may be supported in a 6G network.

To further optimize performance of the wireless network, some typical AI algorithms such as federated learning and split learning may be supported. For example, in a possible split learning scenario, when a terminal needs to complete a model inference task, but computing power of the terminal is insufficient, the terminal may jointly complete the inference task with assistance of a network-side computing power resource by using a model split-based device-edge assistance framework, to satisfy a performance requirement.

However, currently, a method for supporting the split learning in the wireless network is not implemented.

### SUMMARY

This application provides a communication method and an apparatus, to support split learning in a wireless network.

According to a first aspect, this application provides a communication method. The method may be applied to a first apparatus, a functional module in the first apparatus, a processor or a chip in the first apparatus, or the like. For example, the method is applied to the first apparatus. The method may include: The first apparatus sends second information to a second apparatus after determining a first split point based on first information, where the second information indicates the first split point. The first split point corresponds to a first model, and the first model is used for split learning. The first information may include one or more of the following: a split point expected by a terminal, electricity quantity information of the terminal, a storage capability of the terminal, computing power of the terminal, or a measurement result related to channel quality.

According to the foregoing method, in a wireless network, after determining a split point based on the first information, the first apparatus may indicate the split point to the second apparatus, so that the split point can be flexibly adjusted, and split learning can be implemented.

In a possible implementation, the first apparatus may receive the first information from the second apparatus before determining the first split point based on the first information. The possible implementation is applicable to a case in which the first apparatus is a network apparatus and the second apparatus is the terminal. In this case, the network apparatus can accurately determine the first split point based on information reported by the terminal.

In a possible implementation, the first information may be user equipment assistance information (UAI). In this way, an existing message can be reused, and an implementation is simple.

In a possible implementation, the first information may be a measurement report message. In this way, an existing message can be reused, and an implementation is simple.

In a possible implementation, a method in which the first apparatus determines the first split point based on the second information may be that the first apparatus receives a split point adjustment condition from the second apparatus; and the first apparatus further determines the first split point when determining that the measurement result related to the channel quality satisfies the split point adjustment condition. The possible implementation is applicable to a case in which the first apparatus is the terminal and the second apparatus is a network apparatus. In this case, the terminal can determine an accurate first split point when a specific condition is satisfied.

In a possible implementation, the second information may include an identifier of the first split point. In this way, the first split point can be directly indicated to the second apparatus, and an implementation is simple.

In a possible implementation, the second information may include a first field, and the first field indicates the first split point. In this way, the first split point can be flexibly indicated to the second apparatus.

In a possible implementation, the second information may further include a second field, and the second field indicates the first model. In this way, a model of a split point can be clearly adjusted.

In a possible implementation, a bit occupied by the first field may be predefined, or the bit occupied by the first field may be determined based on a total quantity of split points, or the bit occupied by the first field may be configured by the network apparatus. In this way, the first field can be flexibly determined, to indicate the first split point.

In a possible implementation, there is an association relationship between a resource carrying the second information and the first split point, and the association relationship is configured by the network apparatus or predefined. In this way, the first split point can be indirectly indicated, to reduce indication overheads.

In a possible implementation, the second information may further include a third field, and the third field indicates a split point group to which the first split point belongs. In this way, a split point in a group can be flexibly adjusted, and overheads can be reduced.

In a possible implementation, the first apparatus may send third information to the second apparatus, where the third information indicates a split point group to which the first split point belongs. The possible implementation is applicable to the case in which the first apparatus is the network apparatus and the second apparatus is the terminal. In this case, a split point in a group can be flexibly adjusted subsequently, and overheads can be reduced.

In a possible implementation, the first apparatus receives fourth information from the second apparatus, where the fourth information indicates the second apparatus to start to use the first split point. In this way, the first apparatus and the second apparatus can implement split point alignment.

In a possible implementation, the first apparatus sends configuration information to the second apparatus, or the first apparatus receives the configuration information from the second apparatus, where the configuration information may be for configuring information about the first model, and the information about the first model includes a total quantity of split points and/or an initial split point. In this way, the first model can be configured, to perform subsequent split point adjustment.

In a possible implementation, the first apparatus may be a chip.

According to a second aspect, this application provides a communication method. The method may be applied to a second apparatus, a functional module in the second apparatus, a processor or a chip in the second apparatus, or the like. For example, the method is applied to the second apparatus. The method may include: The second apparatus receives second information from a first apparatus, where the second information indicates a first split point. Further, the second apparatus uses the first split point based on the second information, where the first split point corresponds to a first model, and the first model is used for split learning.

According to the foregoing method, in a wireless network, after determining a split point, the first apparatus may indicate the split point to the second apparatus, so that the split point can be flexibly adjusted, and split learning can be implemented.

In a possible implementation, before the second apparatus receives the second information from the first apparatus, the second apparatus may send first information to the first apparatus, where the first information includes one or more of the following: a split point expected by a terminal, electricity quantity information of the terminal, a storage capability of the terminal, computing power of the terminal, or a measurement result related to channel quality. The possible implementation is applicable to a case in which the first apparatus is a network apparatus and the second apparatus is the terminal. In this case, the network apparatus can accurately determine the first split point based on information reported by the terminal.

In a possible implementation, the first information may be UAI. In this way, an existing message can be reused, and an implementation is simple.

In a possible implementation, the first information may be a measurement report. In this way, an existing message can be reused, and an implementation is simple.

In a possible implementation, before the second apparatus receives the second information from the first apparatus, the second apparatus sends a split point adjustment condition to the first apparatus. The possible implementation is applicable to a case in which the first apparatus is the terminal and the second apparatus is a network apparatus. In this case, the terminal can determine an accurate first split point when a specific condition is satisfied.

In a possible implementation, the second information may include an identifier of the first split point. In this way, the first split point can be directly indicated to the second apparatus, and an implementation is simple.

In a possible implementation, the second information may include a first field, and the first field indicates the first split point. In this way, the first split point can be flexibly indicated to the second apparatus.

In a possible implementation, the second information may further include a second field, and the second field indicates the first model. In this way, a model of a split point can be clearly adjusted.

In a possible implementation, a bit occupied by the first field is predefined, or the bit occupied by the first field is determined based on a total quantity of split points, or the bit occupied by the first field is configured by the network apparatus. In this way, the first field can be flexibly determined, to indicate the first split point.

In a possible implementation, there is an association relationship between a resource carrying the second information and the first split point, and the association relationship is configured by the network apparatus or predefined. In this way, the first split point can be indirectly indicated, reduce indication overheads.

In a possible implementation, the second information may further include a third field, and the third field indicates a split point group to which the first split point belongs. In this way, a split point in a group can be flexibly adjusted, and overheads can be reduced.

In a possible implementation, the second apparatus may receive third information from the first apparatus, where the third information indicates a split point group to which the first split point belongs. The possible implementation is applicable to the case in which the first apparatus is the network apparatus and the second apparatus is the terminal. In this case, a split point in a group can be flexibly adjusted subsequently, and overheads can be reduced.

In a possible implementation, a method in which the second apparatus uses the first split point based on the second information may be that the second apparatus may start to use the first split point after determining the first split point based on the second information; or the second apparatus may start to use the first split point in first duration starting from a moment at which the second information is received; or the second apparatus may start to use the first split point after receiving the second information and completing data transmission at a current split point. In this way, the second apparatus can adjust a split point in time when a specific condition is satisfied.

In a possible implementation, the first duration is related to a capability of the terminal. In this way, the second apparatus can adjust a split point with reference to an actual status.

In a possible implementation, the second apparatus may send fourth information to the first apparatus, where the fourth information indicates the second apparatus to start to use the first split point. In this way, the first apparatus and the second apparatus can implement split point alignment.

In a possible implementation, the second apparatus may receive configuration information from the first apparatus, or the second apparatus sends the configuration information to the first apparatus, where the configuration information is for configuring information about the first model, and the information about the first model includes a total quantity of split points and/or an initial split point. In this way, the first model can be configured, to perform subsequent split point adjustment.

In a possible implementation, the second apparatus may be a chip.

According to a third aspect, this application further provides a communication apparatus. The communication apparatus may be a first apparatus, a processor, a chip, a functional module in the first apparatus, or the like. The communication apparatus has functions of implementing the first apparatus in the first aspect or the possible implementation examples of the first aspect. The function may be implemented by hardware, or may be implemented by hardware executing corresponding software. The hardware or the software includes one or more modules corresponding to the foregoing function.

In a possible implementation, a structure of the communication apparatus includes a transceiver unit and a processing unit. These units may perform corresponding functions of the first apparatus in the first aspect or the possible implementation examples of the first aspect. For details, refer to detailed descriptions in the method examples.

In a possible implementation, a structure of the communication apparatus includes a processor, and optionally, further includes a memory and/or a communication interface. The communication interface is configured to: receive and send information, a signal, or data, and communicate and interact with another device in a communication system. The processor is configured to support the communication apparatus in performing corresponding functions of the first apparatus in the first aspect or the possible implementation examples of the first aspect. The memory is coupled to the processor, and stores computer instructions, a logic circuit, or data that is necessary for the communication apparatus.

According to a fourth aspect, this application further provides a communication apparatus. The communication apparatus may be a second apparatus, a processor, a chip, or a functional module in the second apparatus, or the like. The communication apparatus has functions of implementing the second apparatus in the second aspect or the possible implementation examples of the second aspect. The function may be implemented by hardware, or may be implemented by hardware executing corresponding software. The hardware or the software includes one or more modules corresponding to the foregoing function.

In a possible implementation, a structure of the communication apparatus includes a transceiver unit and a processing unit. These units may perform corresponding functions of the second apparatus in the second aspect or the possible implementation examples of the second aspect. For details, refer to detailed descriptions in the method examples.

In a possible implementation, a structure of the communication apparatus includes a processor, and optionally, further includes a memory and/or a communication interface. The communication interface is configured to: receive and send information, a signal, or data, and communicate and interact with another device in a communication system. The processor is configured to support the communication apparatus in performing corresponding functions of the second apparatus in the second aspect or the possible implementation examples of the second aspect. The memory is coupled to the processor, and stores computer instructions, a logic circuit, or data that is necessary for the communication apparatus.

According to a fifth aspect, an embodiment of this application provides a communication system. The communication system may include the first apparatus, the second apparatus, and the like mentioned above.

According to a sixth aspect, an embodiment of this application provides a computer-readable storage medium. The computer-readable storage medium stores program instructions, and when the program instructions are run on a computer, the computer is enabled to perform the method in any one of the first aspect and the possible implementations of the first aspect or any one of the second aspect and the possible implementations of the second aspect in embodiments of this application. For example, the computer-readable storage medium may be any usable medium that can be accessed by the computer. By way of example but not limitation, the computer-readable medium may include a non-transitory computer-readable medium, a random access memory (RAM), a read-only memory (ROM), an electrically erasable programmable read-only memory (EEPROM), a CD-ROM or another optical disk storage, a magnetic disk storage medium or another magnetic storage device, or any other medium that can carry or store desired program code in a form of instructions or a data structure and that can be accessed by the computer.

According to a seventh aspect, an embodiment of this application provides a computer program product, including computer program code or instructions. When the computer program code or the instructions are run on a computer, the method in any one of the first aspect or the possible implementations of the first aspect or any one of the second aspect or the possible implementations of the second aspect is performed.

According to an eighth aspect, this application further provides a chip, including a processor. The processor is coupled to a memory, and is configured to read and execute program instructions stored in the memory, so that the chip implements the method in any one of the first aspect or the possible implementations of the first aspect or any one of the second aspect or the possible implementations of the second aspect.

For each of the third aspect to the eighth aspect and technical effects that can be achieved in the aspect, refer to the foregoing descriptions of the technical effects that can be achieved in the first aspect or the possible solutions in the first aspect or the second aspect or the possible solutions in the second aspect.

### BRIEF DESCRIPTION OF DRAWINGS

FIG. 1 is a diagram of an architecture of a communication system according to an example embodiment of this application;

FIG. 2 is a diagram of an architecture of another communication system according to an example embodiment of this application;

FIG. 3 is a diagram of an architecture of another communication system according to an example embodiment of this application;

FIG. 4 is a diagram of an architecture of another communication system according to an example embodiment of this application;

FIG. 5 is a diagram of interaction in a communication method according to an example embodiment of this application;

FIG. 6 is a diagram of a first model according to an example embodiment of this application;

FIG. 7 is a diagram of a structure of a communication apparatus according to an example embodiment of this application;

FIG. 8 is a diagram of a structure of a communication apparatus according to an example embodiment of this application; and

FIG. 9 is a diagram of a structure of another communication apparatus according to an example embodiment of this application.

### DESCRIPTION OF EMBODIMENTS

The following further describes in detail this application with reference to the accompanying drawings.

Embodiments of this application provide a communication method and an apparatus, to support split learning in a wireless network. The method and the apparatus in this application are based on a same technical concept. Because problem-resolving principles of the method and the apparatus are similar, mutual reference may be made to implementations of the apparatus and the method, and repeated parts are not described.

For ease of understanding, the following describes some terms used in embodiments of this application.

(1) A terminal in embodiments of this application may be a device that provides a user with voice and/or data connectivity, a mobile device having a wireless connection function, or another processing device connected to a wireless modem.

The terminal is also referred to as user equipment (UE), a mobile station (MS), a mobile terminal (MT), or the like. The terminal is a device that includes a wireless communication function (providing a user with voice/data connectivity), for example, a handheld device or a vehicle-mounted device that has a wireless connection function. Currently, some examples of the terminal are: a mobile phone, a satellite phone, a cellular phone, a tablet computer, a notebook computer, a palmtop computer, a mobile internet device (MID), customer-premises equipment (CPE), an intelligent point of sale (POS) terminal, a wearable device, an uncrewed aerial vehicle, a communication device carried on a high-altitude aircraft, a virtual reality (VR) device, an augmented reality (AR) device, a wireless terminal in industrial control, a wireless terminal in vehicle-to-everything (V2X), a wireless terminal in self-driving, a wireless terminal in remote medical surgery, a wireless terminal in a smart grid, a wireless terminal in transportation safety, a wireless terminal in a smart city, a wireless terminal in a smart home, or a terminal in a communication system evolved after 5G. For example, the wireless terminal in the vehicle-to-everything may be a vehicle-mounted device, an entire vehicle device, a vehicle-mounted module, or a vehicle. The wireless terminal in the industrial control may be a camera, a robot, or the like. The wireless terminal in the smart home may be a television, an air conditioner, a sweeper, a speaker, a set-top box, or the like. In this application, a terminal having a wireless transceiver function, a chip or a module that can be disposed in the foregoing terminal, and the like are collectively referred to as terminals.

(2) A network apparatus in embodiments of this application may be a device in a wireless network. For example, the network apparatus may be a device that is deployed in a radio access network and that provides a wireless communication function for a terminal. For example, the network apparatus may be a radio access network (RAN) node that connects the terminal to the wireless network, and may also be referred to as an access network device. The network apparatus in embodiments of this application may be an evolved NodeB (eNB) in a 4G system, may be a next generation NodeB (gNB) in a 5G system, or may be a base station in a 6G system, or a base station in another system evolved after 5G. Specifically, the network apparatus may include but is not limited to: a home base station (for example, a home evolved NodeB or a home NodeB, HNB), a baseband unit (BBU), a wireless relay node, a wireless backhaul node, a transmission point (TP), a transmission reception point (TRP), or one antenna panel or a group of antenna panels (including a plurality of antenna panels) of a base station in a 5G mobile communication system. Alternatively, the network apparatus may be a network node forming the gNB or the transmission point, for example, a BBU or a distributed unit (DU).

In some deployments, the gNB may include a central unit (CU) and a DU. The gNB may further include an active antenna unit (AAU). The CU implements some functions of the gNB, and the DU implements some functions of the gNB. For example, the CU is responsible for processing a non-real-time protocol and service, and implements functions of a radio resource control (RRC) layer and a packet data convergence protocol (PDCP) layer. The DU is responsible for processing a physical layer protocol and a real-time service, and implements functions of a radio link control (RLC) layer, a MAC layer, and a physical (PHY) layer. The AAU implements some physical layer processing functions, radio frequency processing, and a function related to an active antenna. Information at the RRC layer is finally changed to information at the PHY layer, or is changed from information at the PHY layer. Therefore, in this architecture, higher layer signaling (for example, RRC layer signaling) may also be considered as being sent by the DU, or sent by the DU and the AAU. It may be understood that the network apparatus may be a device including one or more of a CU node, a DU node, and an AAU node. In addition, the CU may be classified as a network apparatus in the RAN, or the CU may be classified as a network apparatus in a core network (CN). This is not limited in this application.

(3) Split learning is a technology in machine learning. A key idea of the split learning is to execute, between a client and a server, a split model based on each layer, and the model is used for training and inference. A simplest configuration of the split learning is that each client calculates an output of a split layer, and then forwards a calculation result. To be specific, data is sent to another server or client, and then the server or the client completes remaining calculation.

The split learning may also be referred to as cut learning, division learning, or the like.

(4) A split point may also be referred to as a split layer or a cut layer. In a split learning scenario, a structure of a neural network is divided, and only a part of the structure of the neural network is reserved for each device. In a training process, subnetwork structures of all devices form a complete model. A network structure boundary between devices may be referred to as a cut layer.

(5) In the descriptions of this application, words such as “first” and “second” are merely used for distinguishing for description, and cannot be understood as an indication or implication of relative importance, or cannot be understood as an indication or implication of an order.

(6) In the descriptions of this application, “at least one (type)” means one or more (types), and “a plurality of (types)” means two or more (types). “At least one of the following” or a similar expression thereof means any combination of these items, including any combination of a single item or a plurality of items. For example, at least one of a, b, or c may indicate a, b, c, a and b, a and c, b and c, or a, b, and c, where a, b, and c may be singular or plural.

(7) In embodiments of this application, the term “and/or” describes an association relationship between associated objects and may indicate at least three relationships. For example, A and/or B may indicate the following cases: Only A exists, both A and B exist, and only B exists, where A and B may be singular or plural. “/” indicates “or”. For example, a/b indicates a or b.

To describe the technical solutions in embodiments of this application more clearly, the following describes a communication method and an apparatus provided in embodiments of this application in detail with reference to the accompanying drawings.

The technical solutions provided in this application may be applied to various communication systems, for example, may be applied to a 4th generation (4G) communication system, for example, a long term evolution (LTE) system; may be applied to a 5th generation (5G) communication system, for example, a new radio (NR) system; or may be applied to various communication systems evolved after 5G, for example, a 6th generation (6G) communication system. This application may be further applied to another wireless communication system that supports AI, and application scenarios include but are not limited to scenarios such as terrestrial cellular communication, satellite communication, vehicle-to-everything (V2X) communication, and integrated access and backhaul (JAB).

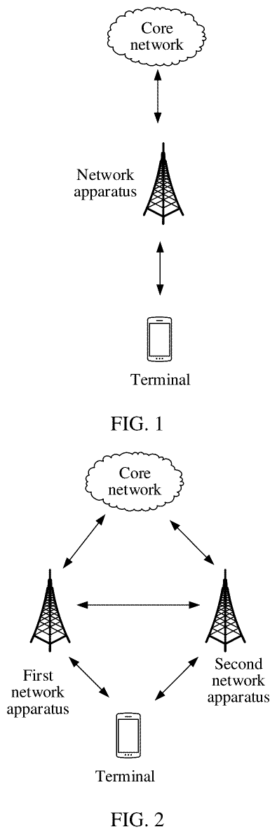

For example, FIG. 1 shows an architecture of a possible communication system to which an embodiment of this application is applicable. The architecture of the communication system may be an architecture in a standalone (SA) scenario. In the communication system, a terminal may be connected to one network apparatus. The network apparatus connected to the terminal and a core network connected to the network apparatus may be of a same standard. For example, if the core network is a 5G core network, the network apparatus is a 5G network apparatus. Alternatively, if the core network is a 6G core network, the network apparatus is a 6G network apparatus.

FIG. 2 shows an architecture of another possible communication system to which an embodiment of this application is applicable. The architecture of the communication system may be an architecture in a dual connectivity (DC) scenario. In the communication system, a terminal may be connected to two network apparatuses of different standards or a same standard, and the two network apparatuses may belong to a same core network. For example, in FIG. 2, the terminal establishes connections to both a first network apparatus and a second network apparatus. The first network apparatus may be a network apparatus in 4G, a network apparatus in 5G, or a network apparatus in 6G. Similarly, the second network apparatus may be a network apparatus in 4G, a network apparatus in 5G, or a network apparatus in 6G. The core network may be a 5G core network, a 6G core network, or the like.

During actual application, when the terminal establishes connections to both the network apparatus in 5G and the network apparatus in 4G, the network apparatus in 5G may be used as a master station, and the network apparatus in 4G may be used as a secondary station. Alternatively, the network apparatus in 4G may be used as a master station, and the network apparatus in 5G may be used as a secondary station. Similarly, when the terminal establishes connections to both the network apparatus in 5G and the network apparatus in 6G, the network apparatus in 5G may be used as a master station, and the network apparatus in 6G may be used as a secondary station. Alternatively, the network apparatus in 6G may be used as a master station, and the network apparatus in 5G may be used as a secondary station. Other cases are deduced by analogy.

For example, the core network is the 5G core network, and the terminal is connected to both the network apparatus in 5G and the network apparatus in 6G, where the network apparatus in 5G is used as a master station, and the network apparatus in 6G is used as a secondary station. For another example, the core network is the 6G core network, and the terminal is connected to both the network apparatus in 6G and the network apparatus in 5G, where the network apparatus in 6G is used as a master station, and the network apparatus in 5G is used as a secondary station. For another example, the core network is the 6G core network, and the terminal is connected to two network apparatuses in 6G, that is, both a master node and a secondary node are network apparatuses in 6G.

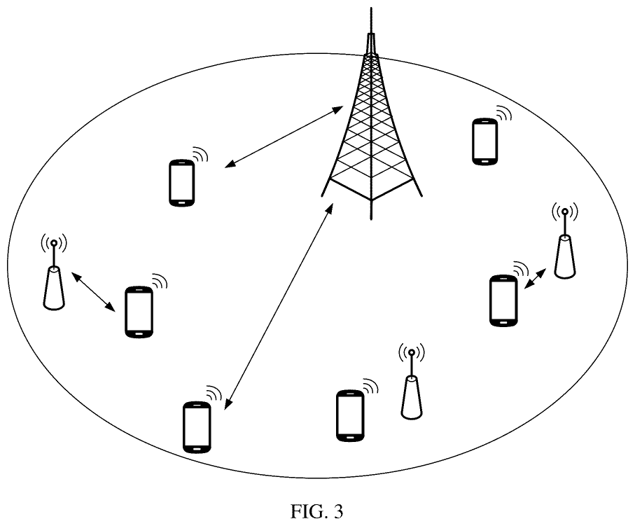

FIG. 3 shows an architecture of another possible communication system to which an embodiment of this application is applicable. The architecture of the communication system may be an architecture in a scenario in which both a wide-coverage network apparatus and a small-coverage network apparatus exist, for example, an architecture in a macro-micro scenario. In FIG. 3, a first network apparatus may be a wide-coverage network apparatus, and a second network apparatus, a third network apparatus, and a fourth network apparatus may be small-coverage network apparatuses. Any network apparatus may be a network apparatus in 4G, a network apparatus in 5G, or a network apparatus in 6G.

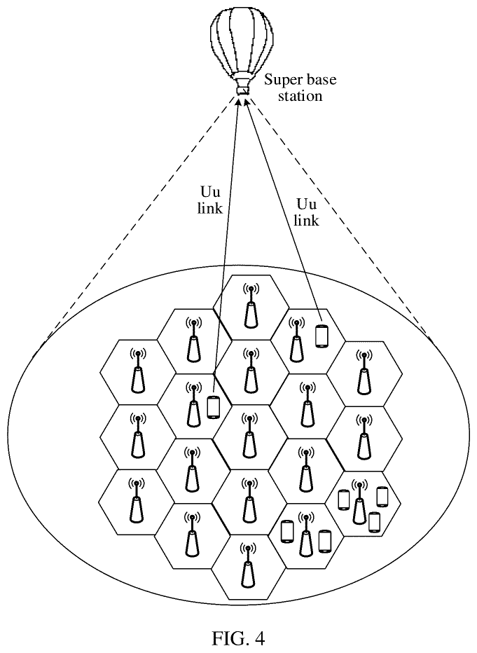

FIG. 4 shows an architecture of another possible communication system to which an embodiment of this application is applicable. The architecture of the communication system may be an architecture in a macro-micro scenario including base stations in different forms in a wireless communication network. For example, in FIG. 4, a super base station (BS) may be in a plurality of forms such as a satellite, an air balloon station, and a drone station, and a terrestrial station in FIG. 4 may be a current cellular station (in a plurality of forms such as a macro station, a small cell, and a micro station).

With continuous development of communication technologies, starting from a 5G system, an AI algorithm has been applied to a wireless network. In a 5.5G system and a 6G system, AI may play an increasingly important role in the wireless network, and provide more functions, to make a network more intelligent. For example, native AI may be supported in a 6G network.

To further optimize performance of the wireless network, some typical AI algorithms such as federated learning and split learning may be supported. For example, in a possible split learning scenario, when a terminal needs to complete a model inference task, but computing power of the terminal is insufficient, the terminal may jointly complete the inference task with assistance of a network-side computing power resource by using a model split-based device-edge assistance framework, to satisfy a performance requirement.

However, although it is proposed to implement split learning in the future, there is currently no method to support split learning in a wireless network. Based on this, this application provides a communication method, to support the split learning in the wireless network.

It should be noted that, in the following embodiments, the communication method provided in this application is described in detail by using a first apparatus and a second apparatus as examples. It should be understood that operations performed by the first apparatus may alternatively be implemented by using a processor, a chip, a chip system, a functional module, or the like in the first apparatus; and operations performed by the second apparatus may alternatively be implemented by using a processor, a chip, a chip system, a functional module, or the like in the second apparatus. This is not limited in this application.

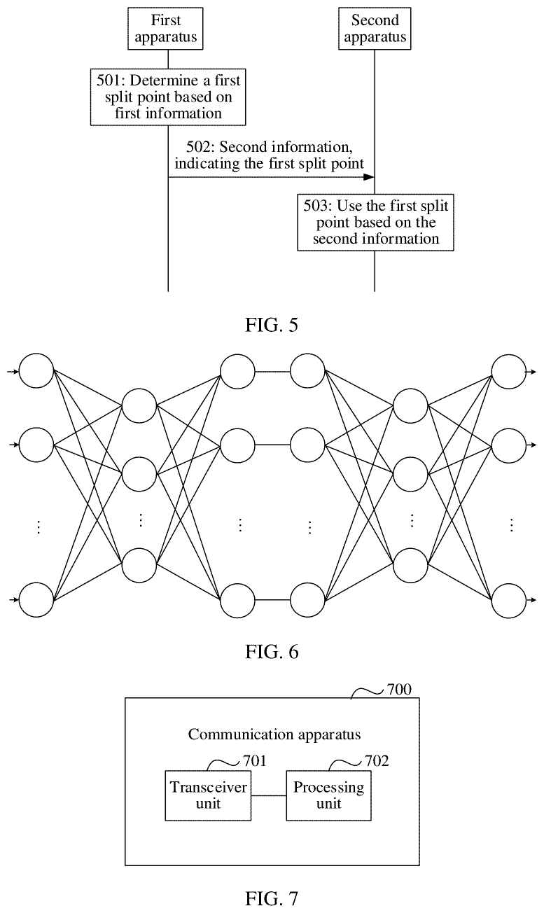

Based on the foregoing descriptions, an embodiment of this application provides a communication method. As shown in FIG. 5, a procedure of the method may include the following steps.

Step 501: The first apparatus determines a first split point based on first information. The first split point may correspond to a first model, and the first model is used for split learning. The first information may include one or more of the following: a split point expected by a terminal, electricity quantity information of the terminal, a storage capability of the terminal, computing power of the terminal, or a measurement result related to channel quality.

Step 502: The first apparatus sends second information to the second apparatus, and correspondingly, the second apparatus receives the second information from the first apparatus, where the second information may indicate the first split point.

Step 503: The second apparatus uses the first split point based on the second information.

According to the foregoing method, in a wireless network, after determining a split point based on the first information, the first apparatus may indicate the split point to the second apparatus, so that the split point can be flexibly adjusted, and split learning can be implemented.

In a possible scenario a1, the first apparatus is a network apparatus, and the second apparatus is the terminal. In other words, in this scenario, after determining a split point, the network apparatus indicates the determined split point to the terminal.

In another possible scenario a2, the first apparatus is the terminal, and the second apparatus is a network apparatus. In other words, in this scenario, after determining a split point, the terminal indicates the determined split point to the network apparatus.

In a specific implementation, to enable one or more AI training models used for split learning, in an initial phase of model training, the network apparatus may configure related information of a model. For example, when there are a plurality of models, the network apparatus configures related information of models for the terminal. For example, the related information of the models may include one or more of the following: a total quantity of split points, an initial split point, or a weight of each neuron. Optionally, the network apparatus may configure the related information of the models by using a radio resource control (RRC) message (for example, an RRC reconfiguration message).

For one time of model training, the network apparatus may indicate, to the terminal, a model trained this time.

In a possible implementation, the network apparatus sends first configuration information to the terminal, where the first configuration information is for configuring N models, and N may be an integer greater than or equal to 1. Optionally, the first configuration information may be carried in the RRC reconfiguration message.

In a possible implementation, the network apparatus may further send second configuration information to the terminal, where the second configuration information indicates a model trained in a single time, or indicates a model trained in a period of time. The period of time may be predetermined in a protocol, or may be indicated by the second configuration information changes.

Optionally, the second configuration information may be carried in downlink control information (DCI) or a media access control control element (MAC CE). Optionally, the model indicated by the second configuration information is one of the N models configured by using the first configuration information. For example, a field may be defined in the DCI or the MAC CE, to indicate one of the N models.

Optionally, the second configuration information may be carried in the RRC message. For example, the network apparatus may indicate, by using the RRC reconfiguration message, a specific model trained this time.

When the trained model changes, the network apparatus may indicate a model change to the terminal, for example, may indicate the model change by using the RRC reconfiguration message, the MAC CE, or the DCI. If the network apparatus previously configures related information of a newly changed model, the network apparatus may send a model switching indication to the terminal. If the network apparatus does not configure the related information of the newly changed model, the network apparatus may configure the related information of the newly changed model for the terminal, for example, a total quantity of split points of the newly changed model.

In this application, an example in which the trained model is the first model is used. The following separately describes the method in this application based on the scenario a1 and the scenario a2.

For the scenario a1, the first apparatus is the network apparatus, and the second apparatus is the terminal.

The first apparatus sends configuration information to the second apparatus, where the configuration information is for configuring information about the first model, and the information about the first model may include one or more of the following: a total quantity of split points of the first model, an initial split point, a weight of each neuron, or the like.

For example, a diagram of the first model may be shown in FIG. 6. For example, the total quantity of split points of the first model may be equal to a quantity of layers of the first model. To reduce overheads, the total quantity of split points of the first model may alternatively be less than the quantity of layers of the first model. For example, the first model includes five layers, and three of the five layers are split points.

In an optional implementation, before the first apparatus determines the first split point based on the first information, the first apparatus may receive the first information from the second apparatus.

In an example, the first information may include UE assistance information (UAI). In this example, the first information may include one or more of the following: the split point expected by the terminal, the electricity quantity information of the terminal, the storage capability of the terminal, or the computing power of the terminal. Optionally, the electricity quantity information of the terminal may be a low electricity quantity indication of the terminal, the storage capability of the terminal may be a low storage capability indication of the terminal, and the computing power of the terminal may be a low computing power indication of the terminal. For example, the low electricity quantity indication of the terminal may be implemented by using a remaining electricity quantity value of the terminal, the low storage capability indication of the terminal may be implemented by using remaining available memory, and the low computing power indication of the terminal may be implemented by using remaining computing power of the terminal. It should be understood that the foregoing indications may alternatively be implemented in another manner. This is not limited in this application.

Optionally, the first information may alternatively include a measurement report message or the like.

In another example, the first information may include the measurement result related to the channel quality or a measurement result of another parameter. The measurement result related to the channel quality may be but is not limited to measurement results of the following parameters: reference signal received power (reference signal received power, RSRP), reference signal received quality (reference signal received quality, RSRQ), a signal to interference plus noise ratio (signal to interference plus noise ratio, SINR), or the like. The foregoing parameters may be referred to as parameters related to the channel quality. The another parameter may be but is not limited to a parameter for representing computing power, a storage capability, or the like. A name of the another parameter is not limited in this application.

Specifically, one or more measurement events related to a split point may be predefined.

For example, when one measurement event is predefined, the measurement event may include a threshold of one parameter related to the channel quality or a threshold of another parameter. When a measurement result obtained by the terminal by measuring the parameter related to the channel quality or the another parameter is greater than or less than a corresponding threshold, the terminal reports the measurement result related to the channel quality or the measurement result of the another parameter to the network apparatus. Alternatively, optionally, the terminal may periodically report the measurement result related to the channel quality or the measurement result of the another parameter to the network apparatus.

For another example, when a plurality of measurement events are predefined, each measurement event may be associated with a threshold of one parameter related to the channel quality or a threshold of the another parameter, and there is an association relationship between each threshold and a split point. For example, each measurement event corresponds to one split point, and the terminal reports the measurement result related to the channel quality or the measurement result of the another parameter, so that the network apparatus determines a corresponding related point.

Correspondingly, after the first apparatus determines the first split point, the first apparatus may indicate the first split point by using the second information in the following manners.

Manner b1: The second information may include an identifier of the first split point.

Optionally, the identifier of the first split point may be any indication information of the first split point.

For example, in the manner b1, the second information may be RRC signaling, or the second information is included in the RRC signaling.

Manner b2: The second information may include a first field, and the first field indicates the first split point.

A bit occupied by the first field may be predefined, or the bit occupied by the first field may be determined based on the total quantity of split points, or the bit occupied by the first field may be configured by the network apparatus.

In a possible implementation, the second information may be a MAC CE, or the second information is included in the MAC CE.

For example, the second information is a MAC CE. It is assumed that a quantity of bits occupied by the first field in the MAC CE is determined based on the total quantity of split points. For example, when the total quantity of split points is 10, the split points may need to be indicated by using four bits. In this case, an example in which the MAC CE indicates the first split point may be shown in Table 1.

TABLE 1

| | | | | | | | |
|---|---|---|---|---|---|---|---|
| 0 | 1 | 2 | 3 | 4 | 5 | 6 | 7 |

| | | | | |
|---|---|---|---|---|
| R | R | R | R | First field |

As shown in Table 1, a byte alignment solution may be used for the first field. When the MAC CE includes eight bits, the first field occupies the last four bits, and the first four bits are set as reserved (R) bits. The first field may also be referred to as a split point indicator field. It should be noted that, in Table 1, only an example in which the first four bits are set as the reserved bits is shown. Optionally, the last four bits may be set as reserved bits, or another reservation manner may be used. This is not limited in this application.

In a possible implementation, the second information may be DCI, or the second information is included in the DCI.

For example, the second information is DCI. It is assumed that a quantity of bits occupied by the first field in the DCI is determined based on the total quantity of split points. For example, when the total quantity of split points is 5, the split points may need to be indicated by using three bits. In this case, an example in which the DCI indicates the first split point may be shown in Table 2.

TABLE 2

| | Value of a first field | | | | | | | |
|---|---|---|---|---|---|---|---|---|
| | 000 | 001 | 010 | 011 | 100 | 101 | 110 | 111 |
| Split point | Point 0 | Point 1 | Point 2 | Point 3 | Point 4 | Point 5 | Reserved | Reserved |

As shown in Table 2, the first field occupies three bits in the DCI, and different values of the three bits may indicate different split points. The first field may also be referred to as a DCI split point indicator (SPI) field.

Optionally, when there are a plurality of models, the second information may further include a second field, and the second field indicates the first model. For example, when the second information is a MAC CE, the MAC CE may indicate both a model index (Model index) and a split point indicator in a model. For example, an indication of the MAC CE may be shown in Table 3.

TABLE 3

| | | | | | | | |
|---|---|---|---|---|---|---|---|
| 0 | 1 | 2 | 3 | 4 | 5 | 6 | 7 |

| | | | |
|---|---|---|---|
| R | R | Model index | Split point indicator |

| | | |
|---|---|---|
| R | Model index | Split point indicator |

| | | | |
|---|---|---|---|
| R | R | Model index | Split point indicator |

The model index in Table 3 indicates the model indicated by the second field.

Optionally, models may be byte-aligned, as shown in Table 3.

Manner b3: Indication is performed based on grouping of split points.

To reduce indication overheads, the split points may be grouped. In a specific indication manner, the split points may be indicated in a group. For example, the split points are indicated in the group in the manner b1 or the manner b2.

For example, the split points are divided into one or more groups (groups). For example, there are a total of eight split points, and the split points may be divided into two groups based on characteristics of the split points. A split point group 1 may include split points 0 to 3. A characteristic of the group of split points may be that a corresponding amount of transmitted data is large, and therefore, air interface signaling overheads are high, and a calculation amount of the terminal is small. A split point group 2 may include split points 4 to 7. A characteristic of the group of split points may be that a corresponding amount of transmitted data is small, and therefore air interface signaling overheads are low, and the calculation amount of the terminal is large.

In an optional implementation, the first apparatus may send third information to the second apparatus, where the third information indicates a split point group to which the first split point belongs. In this way, the first split point may be indicated in the split group in the manner b1 or the manner b2, so that the indication overheads can be reduced.

Optionally, the third information may be RRC signaling or MAC CE signaling, or the third information may be included in the RRC signaling or the MAC CE signaling.

In another optional implementation, in the manner b1 or the manner b2, the second information may further include a third field, and the third field indicates a split point group to which the first split point belongs. The third field may also be referred to as a group identifier (Group ID) field. For example, the second information is a MAC CE. An example of the second information may be shown in Table 4.

TABLE 4

| | | | | | | | |
|---|---|---|---|---|---|---|---|
| 0 | 1 | 2 | 3 | 4 | 5 | 6 | 7 |

| | |
|---|---|
| Third field | Split point indicator |

Based on the foregoing method, after the second apparatus receives the second information, the second apparatus uses the first split point based on the second information.

In this application, using the first split point may include starting model training or model inference, or sending an intermediate result of the model training or the model inference to the first apparatus.

For example, there may be the following methods in which the second apparatus uses the first split point based on the second information.

Method c1: The second apparatus starts to use the first split point after determining the first split point based on the second information.

The foregoing method in the manner b1 is used as an example. When the second information is RRC signaling, and the RRC signaling includes the identifier of the first split point, after receiving the RRC signaling, the second apparatus may determine the first split point based on the identifier of the first split point, and then start to use the first split point.

Method c2: The second apparatus starts to use the first split point in first duration starting from a moment at which the second information is received. In this way, a moment at which the first split point starts to be used does not need to be additionally indicated, so that signaling overheads are reduced.

Optionally, the first duration is related to a capability of the terminal.

For example, when the second information is a MAC CE, the first duration may be time at which the MAC CE takes effect. Starting from the moment at which the second information is received, the second apparatus may start to use the first split point when the time at which the MAC CE takes effect expires. Optionally, a unit of the time at which the MAC CE takes effect may be a millisecond, a subframe, a slot, or the like.

For another example, when the second information is DCI, the first duration may be t time units. Optionally, a unit of the time unit may be a subframe, a slot, a non-slot (non-slot), a symbol, or the like. It is assumed that after receiving the second information at a moment n, the second apparatus may start to use the first split point at a moment n+t. n is a positive integer, and t is a positive integer.

Method c3: The second apparatus starts to use the first split point after receiving the second information and completing data transmission at a current split point. In this way, it is ensured that the data transmission at the current split point is completed, and accuracy of model training can be ensured.

After the second apparatus starts to use the first split point, the second apparatus may send fourth information to the first apparatus, where the fourth information indicates the second apparatus to start to use the first split point, to maintain split point alignment between the first apparatus and the second apparatus.

Optionally, when the second information is RRC signaling, the fourth information may be RRC signaling, for example, an RRC reconfiguration complete message. When the second information is a MAC CE, the fourth information may be a MAC CE for acknowledgment. When the second information is DCI, the fourth information may be an uplink signal, channel feedback acknowledgment information, or the like.

Based on the foregoing descriptions, after determining the first split point, the network apparatus notifies the terminal of the first split point. Subsequently, the terminal may start to use the first split point when a specific condition is satisfied, to flexibly adjust the split point.

For the scenario a2, the first apparatus is the terminal, and the second apparatus is the network apparatus.

The second apparatus sends configuration information to the first apparatus. For related descriptions of the configuration information, refer to the foregoing descriptions in the scenario a1. Correspondingly, for the first model, still refer to FIG. 6.

In an optional implementation, there may be the following methods in which the first apparatus determines the first split point based on the first information.

Method d1: The first apparatus may determine the first split point based on at least one of the electricity quantity information of the terminal, the storage capability of the terminal, the computing power of the terminal, the measurement result related to the channel quality, or the like.

Method d2: The first apparatus may receive a split point adjustment condition from the second apparatus, and then the first apparatus determines the first split point when determining that the measurement result related to the channel quality satisfies the split point adjustment condition. In the method, the first information may include the measurement result related to the channel quality.

Optionally, the split point adjustment condition may be that the measurement result related to the channel quality is less than or greater than a corresponding threshold. In other words, the first apparatus determines the first split point when determining that the measurement result related to the channel quality is less than or greater than the corresponding threshold. For example, when the measurement result related to the channel quality is less than the corresponding threshold, the first split point may be set at a layer with a small amount of transmitted data, for example, a layer corresponding to a small amount of data of a neuron. Optionally, when the measurement result related to the channel quality is greater than the corresponding threshold, setting of the first split point may not be limited. In a possible manner, the first split point may be set at a layer with a large amount of transmitted data, for example, a layer corresponding to a large quantity of neurons.

The measurement result related to the channel quality may be but is not limited to measurement results of the following parameters related to the channel quality: RSRP, RSRQ, a SINR, and the like.

Correspondingly, after the first apparatus determines the first split point, the first apparatus may indicate the first split point by using the second information in the following manners.

Manner e1: The second information may include an identifier of the first split point.

Specifically, for specific content of the manner e1, refer to the content in the manner b1.

It should be noted that, in the manner e1, the second information may be RRC signaling, or may be channel state information (CSI) or physical uplink control channel (PUCCH) information.

In the CSI or the PUCCH information, the identifier of the first split point may be an SPI.

Optionally, the CSI may further include one or more of the following: a channel quality indicator (CQI), a precoding matrix indication (PMI), a rank indication (RI), or the like.

Manner e2: The second information may include a first field, and the first field indicates the first split point.

Specifically, for specific content of the manner e2, refer to the content in the manner b2. A difference between the manner e2 and the manner b2 lies in that, in a specific implementation, the second information may be a MAC CE, but cannot be DCI.

Manner e3: There is an association relationship between a resource carrying the second information and the first split point. Optionally, the association relationship may be configured by the network apparatus or predefined. In this way, the corresponding first split point may be determined based on the resource carrying the second information.

The resource carrying the second information may be a resource of an uplink signal, and different split points may be associated with different resources of uplink signals. For example, a resource of an uplink signal may be directly associated with an index of a split point. For example, when a resource of an uplink signal is associated with a split point 1, the split point 1 may be determined based on the resource of the uplink signal. For another example, a resource of an uplink signal may alternatively be indirectly associated with an index of a split point. For example, when a resource of an uplink signal is associated with a split point 1, a split point determined based on the resource of the uplink signal is a split point 0 or a split point 2. In addition to the foregoing examples, there may be another association relationship between a resource of an uplink signal and a split point. This is not limited in this application.

Optionally, the uplink signal may reuse a scheduling request (SR), or may be a newly defined signal. This is not limited in this application.

Manner e4: Indication is performed based on grouping of split points.

Specifically, the manner e4 is similar to the manner b3. For details, refer to content in the manner b3.

Based on the foregoing method, after the second apparatus receives the second information, the second apparatus uses the first split point based on the second information. For example, for a method in which the second apparatus uses the first split point based on the second information, refer to the foregoing methods c1 to c3.

Similarly, after the second apparatus starts to use the first split point, the second apparatus may send fourth information to the first apparatus, where the fourth information indicates the second apparatus to start to use the first split point, to maintain split point alignment between the first apparatus and the second apparatus.

Based on the foregoing descriptions, after determining the first split point, the terminal notifies the network apparatus of the first split point. Subsequently, the network apparatus may start to use the first split point when a specific condition is satisfied, to flexibly adjust the split point.

It should be noted that, in the foregoing descriptions, an example in which the network apparatus and the terminal notify each other of the split point is used for description. In a specific implementation, the foregoing method is also applicable to a case in which terminals notify each other of the split point, to adjust the split point.

Based on the foregoing embodiments, an embodiment of this application further provides a communication apparatus. Refer to FIG. 7. The communication apparatus 700 may include a transceiver unit 701 and a processing unit 702. The transceiver unit 701 is configured to perform communication by the communication apparatus 700, for example, receive information, a message, or data, or send information, a message, or data. The processing unit 702 is configured to control and manage an action of the communication apparatus 700. The processing unit 702 may further control steps performed by the transceiver unit 701.

For example, the communication apparatus 700 may be specifically the first apparatus, or a processor, a chip, a chip system, a functional module, or the like in the first apparatus in the foregoing embodiments. Alternatively, the communication apparatus 700 may be specifically the second apparatus, or a processor, a chip, a chip system, a functional module, or the like in the second apparatus in the foregoing embodiments.

In an embodiment, when the communication apparatus 700 is configured to implement functions of the first apparatus in the foregoing embodiments, the processing unit 702 may be configured to determine a first split point based on first information, and the transceiver unit 701 may be configured to send second information to a second apparatus, where the second information indicates the first split point. The first split point corresponds to a first model, the first model is used for split learning, and the first information includes one or more of the following: a split point expected by a terminal, electricity quantity information of the terminal, a storage capability of the terminal, computing power of the terminal, or a measurement result related to channel quality.

In an optional implementation, when the first apparatus is a network apparatus, and the second apparatus is the terminal, the transceiver unit 701 is further configured to receive the first information from the second apparatus before the processing unit 702 determines the first split point based on the first information.

In a possible implementation, the first information may be UAI.

In a possible implementation, the first information may be a measurement report.

For example, when the first apparatus is the terminal, and the second apparatus is a network apparatus, the transceiver unit 701 may be further configured to receive a split point adjustment condition from the second apparatus. When determining the first split point based on the second information, the processing unit 702 may be specifically configured to determine the first split point when determining that the measurement result related to the channel quality satisfies the split point adjustment condition.

In a possible manner, the second information may include an identifier of the first split point.

In another possible manner, the second information may include a first field, and the first field indicates the first split point.

Optionally, the second information may further include a second field, and the second field indicates the first model.

In another possible manner, there is an association relationship between a resource carrying the second information and the first split point, and the association relationship is configured by the network apparatus or predefined.

Optionally, the second information may further include a third field, and the third field indicates a split point group to which the first split point belongs.

Optionally, when the first apparatus is a network apparatus, and the second apparatus is the terminal, the transceiver unit 701 may be further configured to send third information to the second apparatus, where the third information indicates a split point group to which the first split point belongs.

In an optional implementation, the transceiver unit 701 may be further configured to receive fourth information from the second apparatus, where the fourth information indicates the second apparatus to start to use the first split point.

Optionally, the transceiver unit 701 is further configured to send configuration information to the second apparatus, or the first apparatus receives the configuration information from the second apparatus, where the configuration information is for configuring information about the first model, and the information about the first model includes a total quantity of split points and/or an initial split point.

In another embodiment, when the communication apparatus 700 is configured to implement functions of the second apparatus in the foregoing embodiments, the transceiver unit 701 may be configured to receive second information from a first apparatus, where the second information indicates a first split point, the first split point corresponds to a first model, and the first model is used for split learning; and the processing unit 702 may be configured to use the first split point based on the second information.

In an optional implementation, when the first apparatus is a network apparatus, and the second apparatus is a terminal, the transceiver unit 701 is further configured to send first information to the first apparatus before receiving the second information from the first apparatus, where the first information includes one or more of the following: a split point expected by the terminal, electricity quantity information of the terminal, a storage capability of the terminal, computing power of the terminal, or a measurement result related to channel quality.

In a possible implementation, the first information may be UAI.

In a possible implementation, the first information may be a measurement report.

Optionally, when the first apparatus is a terminal, and the second apparatus is a network apparatus, the transceiver unit 701 is further configured to send a split point adjustment condition to the first apparatus before receiving the second information from the first apparatus.

In an example, the second information may include an identifier of the first split point.

In another example, the second information may include a first field, and the first field indicates the first split point.

Optionally, the second information may further include a second field, and the second field indicates the first model.

In still another example, there is an association relationship between a resource carrying the second information and the first split point, and the association relationship is configured by the network apparatus or predefined.

Optionally, the second information may further include a third field, and the third field indicates a split point group to which the first split point belongs.

Optionally, when the first apparatus is a network apparatus, and the second apparatus is a terminal, the transceiver unit 701 may be further configured to receive third information from the first apparatus, where the third information indicates a split point group to which the first split point belongs.

For example, when using the first split point based on the second information, the processing unit 702 is specifically configured to: start to use the first split point after determining the first split point based on the second information; or start to use the first split point in first duration starting from a moment at which the transceiver unit 701 receives the second information; or start to use the first split point after the transceiver unit 701 receives the second information and completes data transmission at a current split point.

The first duration may be related to a capability of the terminal.

In a possible manner, the transceiver unit 701 is further configured to send fourth information to the first apparatus, where the fourth information indicates the second apparatus to start to use the first split point.

In a possible implementation, the transceiver unit 701 is further configured to receive configuration information from the first apparatus, or the second apparatus sends the configuration information to the first apparatus, where the configuration information is for configuring information about the first model, and the information about the first model includes a total quantity of split points and/or an initial split point.

It should be noted that, in this embodiment of this application, division into the units is an example, and is merely a logical function division. In an actual implementation, another division manner may be used. Functional units in embodiments of this application may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to a conventional technology, or all or some of the technical solutions may be implemented in the form of a software product. The computer software product is stored in a storage medium and includes several instructions for instructing a computer device (which may be a personal computer, a server, a network device, or the like) or a processor (processor) to perform all or some of the steps of the methods described in embodiments of this application. The foregoing storage medium includes any medium that can store program code, such as a USB flash drive, a removable hard disk, a ROM, a RAM, a magnetic disk, or an optical disc.

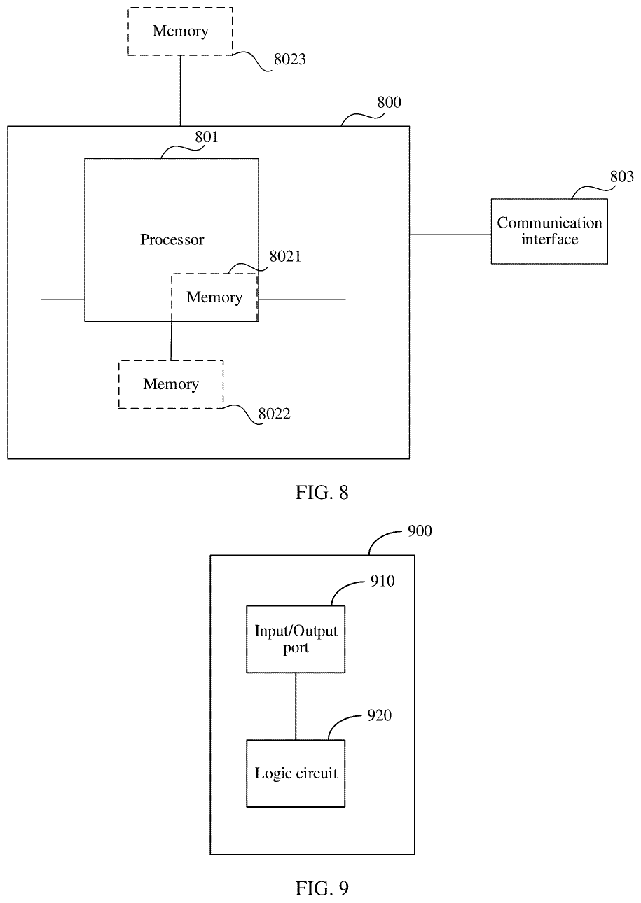

Based on the foregoing embodiments, an embodiment of this application further provides a communication apparatus. Refer to FIG. 8. The communication apparatus 800 may include a processor 801. The processor 801 may be coupled to a memory. Optionally, the memory may be integrated with the processor 801, for example, a memory 8021 in FIG. 8, or may be included in the communication apparatus 800 and disposed separately from the processor 801, for example, a memory 8022 in FIG. 8. Optionally, the memory may alternatively be disposed outside the communication apparatus 800, for example, a memory 8023 in FIG. 8. Optionally, the processor 801 may receive and send a signal, information, a message, and the like through a communication interface 803. The communication interface 803 may be included inside the communication apparatus 800, or may be disposed outside the communication apparatus 800 and connected to the communication apparatus 800.

Specifically, the processor 801 may be a central processing unit (CPU), a network processor (NP), or a combination of a CPU and an NP. The processor 801 may further include a hardware chip. The hardware chip may be an application-specific integrated circuit (ASIC), a programmable logic device (PLD), or a combination thereof. The PLD may be a complex programmable logic device (CPLD), a field programmable logic gate array (FPGA), a generic array logic (GAL), or any combination thereof.

In an optional implementation, the memory is configured to store a program, computer instructions, a logic circuit, or the like. Specifically, the program may include program code, and the program code includes computer operation instructions. The memory may include a RAM, or may further include a non-volatile memory, for example, one or more magnetic disk memories. The processor 801 executes the application program stored in the memory to implement the foregoing functions, to implement functions of the communication apparatus 800.

For example, the communication apparatus 800 may be the first apparatus in the foregoing embodiments, or may be the second apparatus in the foregoing embodiments.

In an embodiment, when the communication apparatus 800 implements functions of the first apparatus in the foregoing embodiments, the processor 801 may implement operations performed by the first apparatus in the foregoing embodiments. For specific related descriptions, refer to the related descriptions in the embodiment shown in FIG. 5.

In another embodiment, when the communication apparatus 800 implements functions of the second apparatus in the foregoing embodiments, the processor 802 may implement operations other than receiving and sending operations performed by the second apparatus in the foregoing embodiments. For specific related descriptions, refer to the related descriptions in the embodiment shown in FIG. 5.

Refer to FIG. 9. An embodiment of this application further provides another communication apparatus 900 that may be configured to implement functions of the first apparatus and the second apparatus in the foregoing methods. The communication apparatus 900 may be a communication apparatus or a chip in the communication apparatus. The communication apparatus may include at least one input/output interface 910 and a logic circuit 920. The input/output interface 910 may be an input/output circuit. The logic circuit 920 may be a signal processor, a chip, or another integrated circuit that can implement the methods in this application.

The at least one input/output interface 910 is configured to input or output information, a signal, data, or the like. For example, when the apparatus is the first apparatus, the input/output interface 910 is configured to output second information. For example, when the apparatus is the second apparatus, the input/output interface 910 is configured to receive second information.

The logic circuit 920 is configured to perform some or all the steps in any one of the methods provided in embodiments of this application. For example, when the apparatus is the first apparatus, the apparatus is configured to perform steps performed by the first apparatus in the possible implementations in the foregoing method embodiments. For example, the logic circuit 920 is configured to determine a first split point based on first information. When the apparatus is the second apparatus, the apparatus is configured to perform steps performed by the second apparatus in the possible implementations in the foregoing method embodiments. For example, the logic circuit 920 is configured to use the first split point based on second information.

When the communication apparatus is a chip used in a terminal, the chip in the terminal implements functions of the terminal in the foregoing method embodiments. The chip in the terminal receives information from another module (for example, a radio frequency module or an antenna) in the terminal, where the information is sent by another terminal or a network apparatus to the terminal. Alternatively, the chip in the terminal outputs information to another module (for example, a radio frequency module or an antenna) in the terminal, where the information is sent by the terminal to another terminal or a network apparatus.

When the communication apparatus is a chip used in a network apparatus, the chip in the network apparatus implements functions of the network apparatus in the foregoing method embodiments. The chip in the network apparatus receives information from another module (for example, a radio frequency module or an antenna) in the network apparatus, where the information is sent by a terminal or another network apparatus to the network apparatus. Alternatively, the chip in the network apparatus outputs information to another module (for example, a radio frequency module or an antenna) in the network apparatus, where the information is sent by the network apparatus to a terminal or another network apparatus.

Based on the foregoing embodiments, an embodiment of this application provides a communication system. The communication system may include the first apparatus, the second apparatus, and the like in the foregoing embodiments.

An embodiment of this application further provides a computer-readable storage medium. The computer-readable storage medium is configured to store a computer program. When the computer program is executed by a computer, the computer may implement the method provided in the embodiment shown in FIG. 5.

An embodiment of this application further provides a computer program product. The computer program product is configured to store a computer program. When the computer program is executed by a computer, the computer may implement the method provided in the embodiment shown in FIG. 5.

An embodiment of this application further provides a chip, including a processor. The processor is coupled to a memory, and is configured to invoke a program in the memory, so that the chip implements the method provided in the embodiment shown in FIG. 5.

An embodiment of this application further provides a chip. The chip is coupled to a memory, and the chip is configured to implement the method provided in the embodiment shown in FIG. 5.

A person skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It is clear that a person skilled in the art can make various modifications and variations to this application without departing from the protection scope of this application. In this way, this application is intended to cover these modifications and variations of this application provided that they fall within the scope of protection of the claims of this application and their equivalent technologies.

1. A communication method, comprising:
determining, by a first apparatus, a first split point based on first information, wherein the first split point corresponds to a first model used for split learning, and the first information comprises one or more of: a split point expected by a terminal, electricity quantity information of the terminal, a storage capability of the terminal, computing power of the terminal, or a measurement result related to channel quality; and
sending, by the first apparatus, second information to a second apparatus, wherein the second information indicates the first split point.

2. The method according to claim 1, wherein before determining, by the first apparatus, the first split point based on first information, the method further comprises:
receiving, by the first apparatus, the first information from the second apparatus.

3. The method according to claim 1, further comprising:
determining, by the first apparatus, the first split point based on the second information;
receiving, by the first apparatus, a split point adjustment condition from the second apparatus; and
determining, by the first apparatus, the first split point in association determining that the measurement result related to the channel quality satisfies the split point adjustment condition.

4. The method according to claim 1, wherein the second information comprises an identifier of the first split point; or the second information comprises a first field indicating the first split point.

5. The method according to claim 1, wherein an association relationship exists between a resource carrying the second information and the first split point.

6. The method according to claim 4, wherein the second information further comprises a third field indicating a split point group to which the first split point belongs.

7. The method according to claim 4, further comprising:
sending, by the first apparatus, third information to the second apparatus, wherein the third information indicates a split point group to which the first split point belongs.

8. The method according to claim 1, further comprising:
sending, by the first apparatus, configuration information to the second apparatus, or receiving, by the first apparatus, the configuration information from the second apparatus, wherein
the configuration information is for the first model, and the information about the first model comprises a total quantity of split points and/or an initial split point.

9. A communication method, comprising:
receiving, by a second apparatus, second information from a first apparatus, wherein the second information indicates a first split point corresponding to a first model, and the first model is used for split learning; and
using, by the second apparatus, the first split point based on the second information.

10. The method according to claim 9, wherein before receiving, by the second apparatus, the second information from the first apparatus, the method further comprises:
sending, by the second apparatus, first information to the first apparatus, wherein the first information comprises one or more of: a split point expected by a terminal, electricity quantity information of the terminal, a storage capability of the terminal, computing power of the terminal, or a measurement result related to channel quality.

11. The method according to claim 9, wherein before receiving, by the second apparatus, the second information from the first apparatus, the method further comprises:
sending, by the second apparatus, a split point adjustment condition to the first apparatus.

12. The method according to claim 9, wherein the second information comprises an identifier of the first split point.

13. The method according to claim 9, wherein using, by the second apparatus, the first split point based on the second information comprises:
starting, by the second apparatus, to use the first split point after determining the first split point based on the second information; or
starting, by the second apparatus, to use the first split point in first duration starting from a moment at which the second information is received; or
starting, by the second apparatus, to use the first split point after receiving the second information and completing data transmission at a current split point.

14. A first apparatus, comprising:
a processor coupled to a memory storing computer-executable instructions which, when executed by the processor, cause the first apparatus to:
determine a first split point based on first information, wherein the first split point corresponds to a first model used for split learning, and the first information comprises one or more of: a split point expected by a terminal, electricity quantity information of the terminal, a storage capability of the terminal, computing power of the terminal, or a measurement result related to channel quality; and
send second information to a second apparatus, wherein the second information indicates the first split point.

15. The apparatus according to claim 14, wherein the first apparatus is further caused to:
receive, before the determining a first split point based on first information, the first information from the second apparatus.

16. The apparatus according to claim 14, wherein the first apparatus is caused to:
determine the first split point based on the second information;
receive a split point adjustment condition from the second apparatus; and
determine the first split point when determining that the measurement result related to the channel quality satisfies the split point adjustment condition.

17. The apparatus according to claim 14, wherein the second information comprises an identifier of the first split point; or the second information comprises a first field indicating the first split point.

18. The apparatus according to claim 17, wherein the second information further comprises a third field indicating a split point group to which the first split point belongs; or
the first apparatus is further caused to: send third information to the second apparatus, wherein the third information indicates a split point group to which the first split point belongs.

19. The apparatus according to claim 14, wherein an association relationship exists between a resource carrying the second information and the first split point.

20. The apparatus according to claim 14, wherein the first apparatus is further caused to:
send configuration information to the second apparatus, or receive the configuration information from the second apparatus, wherein the configuration information is about the first model, and the information about the first model comprises a total quantity of split points and/or an initial split point.
